(19) United States
(12) Patent Application Publication
(10) Pub. No.: US 2002/0003491 A1
(43) Pub. Date: Jan. 10, 2002

(54) Communication antenna reuse for a GNSS receiver

(76) Inventor: Stephen B. Heppe, Purcellville, VA (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,620

(22) Filed: May 4, 2001

Related U.S. Application Data
(60) Provisional application No. 60/202,120, filed on May 5, 2000.

(51) Int. Cl. G01S 5/14

(52) U.S. Cl. 342/357.1

(57) ABSTRACT

This invention uses a single radio communications antenna for receiving the ranging signals of the GNSS and transmitting and receiving the radio communications signals associated with a radio communications device. The invention may be beneficially applied in airborne installations where the GNSS user receiving device does not provide a safety-critical function to the aircraft.

### REFERENCE TO RELATED APPLICATION

The present application claims the benefit of U.S. Provisional Application No. 60/202,120, filed May 5, 2000, whose disclosure is hereby incorporated by reference in its entirety into the present disclosure.

### FIELD OF THE INVENTION

The present invention is directed to the economical reuse of a new or existing communications antenna for the purpose of supporting radio-frequency reception by a Global Navigation Satellite System receiver.

### BACKGROUND OF THE INVENTION

Satellite navigation systems are increasingly used for many applications. Two systems in common use today are the Global Positioning System (GPS) operated by the United States, and the Global Orbiting Navigation Satellite System (GLONASS) operated by the Russian Federation. These two systems are similar in their basic operating principles wherein a user receiving device receives a plurality of precisely-timed ranging signals transmitted respectively by a plurality of satellites, and estimates the current system time as well as the position and velocity of the user device receiving antenna based on the relative time of arrival of the said plurality of signals. The GPS and GLONASS operate with ranging signals transmitted in the 1559-1610 MHz portion of the radio spectrum (other signals are also transmitted, but do not fundamentally alter the invention disclosed herein). The term Global Navigation Satellite System (GNSS) is a generic term used to signify any one or combination of satellite-based navigation systems operating according to the general principles of the GPS and GLONASS, including augmentations to these systems which transmit RF signals intended to be received by a common receiver. Examples of augmentation systems which transmit RF signals intended to be received by a common receiver include but are not limited to the Wide Area Augmentation System (WAAS) being developed by the United States, and L-band “pseudo-satellites” (pseudolites) which generate and transmit modified ranging signals from fixed ground transmitters.

The receiving antenna associated with the GNSS user receiving device is typically designed to yield good performance for the ranging signals associated with the GNSS, and in some cases may include an integrated low-noise amplifier. This antenna may also be integrated into a single housing with a second antenna matched to a different frequency band, or it may be designed to support a second frequency band in addition to the GNSS frequency band.

For aircraft use, the receiving antenna is typically mounted on the top of the aircraft fuselage and the antenna is designed for low wind resistance as well as good RF performance in the frequency band used by the GNSS user receiving device. Typical antennas designed for aircraft use provide on the order of −4.5 dBi gain or better, for an aircraft in straight-and-level flight, at elevation angles of 5 degrees or higher relative to the local horizontal plane. Aircraft in flight typically have direct line-of-sight to a plurality of satellites associated with the GNSS.

If an aircraft owner or operator wishes to install a GNSS user receiving device, current industry practice is that an appropriate antenna must also be installed (if it does not already exist), along with appropriate interwiring to connect the antenna to the GNSS user receiving device. This represents a significant expense. There is at least one product comprising a GPS antenna and a VHF antenna integrated in a single housing. This product avoids the need to mount a separate antenna and penetrate the fuselage pressure vessel at a second location, but requires two cables.

Certain avionics require accurate position and time information. One example is a device conforming to the ICAO standard VHF Data Link Mode 4 (VDL/4), which is a standard for a multichannel radio operating in the VHF band. If accurate position and time information is derived from a GNSS user receiving device, the GNSS user receiving device and VDL/4 device (as an example) may be integrated in a common chassis. In this case the GNSS antenna is connected to the GNSS user receiving device inside the common chassis. Alternatively the GNSS user receiving device and VDL/4 device may be in separate chassis, in which case the GNSS antenna is connected to the GNSS user receiving device and positioning data and timing signals can be transferred across appropriate interwiring, between the two chassis, from the GNSS user receiving device to the VDL/4 device. However, some GNSS user receiving devices do not provide appropriate timing signals as standard outputs. If appropriate timing signals are not available from an external GNSS user receiving device, a second GNSS user receiving device capable of generating the appropriate timing signals may be used if it can be connected to an appropriate antenna. This second GNSS user receiving device could be internal or external to the chassis of the VDL/4 device, although an internal design would be typical. A relevant factor is the required reliability of the timing signals so generated, which may not be as stringent as the required reliability of an external GNSS user receiving device employed for aircraft navigation.

For handheld satellite navigation receivers, the antenna is also typically designed with consideration of the GNSS frequency band of operation. Handheld satellite navigation receivers are sometimes operated in the interior of vehicles or buildings. When operated in the interior of a vehicle or building, the RF signals from the transmitting satellites are typically attenuated by the intervening physical structure(s). The RF signals may also reach the receiving antenna by a plurality of indirect paths, including through windows and other openings, which may lead to signal delays that contribute to a degradation in navigation performance. Nevertheless, if the attenuation in RF signal strength is not too severe, and the degradation caused by indirect signal paths is not too severe, the satellite navigation receiver may operate well enough to satisfy user needs.

Initial acquisition of attenuated or scattered signals may be more difficult than steady-state tracking of said attenuated or scattered signals, and several recent innovations address this problem by disclosing methods to allow long signal integration times, in some cases aided by other signals such as those transmitted by cellular communications base stations. This concept is particularly useful in the context of a combined user device, such as a cellular telephone with integrated GPS receiver.

In some consumer products a single antenna may be shared by several devices operating in different frequency bands. For example, in the aforementioned cellular telephone with integrated GPS receiver, it is possible to rely on a single antenna for the communications device (the cellular telephone) as well as the GNSS user receiving device (the GPS receiver). If the frequency bands are widely separated, one or more of the several devices may suffer a performance degradation as a consequence of the design tradeoffs associated with a single antenna, which may be difficult to design for optimum performance in all operating bands associated with said several devices. Also one or more of the several devices may be effectively disconnected from the antenna for periods of time, for example the GPS receiver in the aforementioned cellular telephone with integrated GPS receiver may be effectively disconnected from the antenna when the cellular telephone is transmitting. This can lead to a further loss of performance. However, the loss in performance due to various factors may be balanced by a desirable reduction in cost, and may be mitigated to a greater or lesser degree by aiding each device with the signals available in the nominally unrelated bands (for example, using a cellular communications signal from an external cellular base station to lock an oscillator in the integrated device, which thereby enables a long integration time for a GPS signal attenuated by intervening structures and a suboptimal antenna).

For aircraft use, a single common antenna supporting a GNSS user receiving device and a radio communications device is not traditionally considered since the radionavigation function, supported by the GNSS user receiving device, is traditionally considered to be a safety-critical function which cannot tolerate any significant loss in performance, either due to a suboptimal antenna, suboptimal antenna placement, or periods of time when the GNSS user receiving device is effectively disconnected from the antenna (for example during periods of time when the radio communications device is transmitting). However, as already noted there is at least one product which integrates two separate antennas, a GNSS antenna and a VHF communications antenna, in a single housing.

FIG. 1 illustrates a traditional system according to the prior art wherein navigation (position and velocity) data and timing signals from a GNSS user receiver device 12 are used by a radio communications device 14. In this traditional system the GNSS user receiver device 12 receives GNSS ranging signals through an antenna 11, and the radio communications device 14 transmits and receives communications signals through an antenna 13 which is distinct from antenna 11. However, antenna 11 and antenna 13 may be housed in a single housing.

FIG. 2 illustrates one possible placement of distinct antennas, according to the prior art, for a GNSS user receiver device and radio communications device installed on an aircraft. In this placement of distinct antennas, the antenna connected to the GNSS user receiver device is top-mounted on the fuselage 21 as shown at position 22, and the antenna connected to the radio communications device is bottom-mounted on the fuselage 21 as shown at position 23. The antenna connected to the radio communications device could alternatively be top-mounted, but the antenna connected to the GNSS user receiver device is typically not bottom-mounted. The two antennas can be in a single housing.

### SUMMARY OF THE INVENTION

This invention uses a single radio communications antenna for receiving the ranging signals of the GNSS and transmitting and receiving the radio communications signals associated with a radio communications device. The invention may be beneficially applied in airborne installations where the GNSS user receiving device is used in conjunction with the radio communications device which requires only intermittent positioning data and timing updates, and where the GNSS user receiving device does not provide a navigation function to the aircraft.

### BRIEF DESCRIPTION OF DRAWINGS

FIG. 1 illustrates a traditional system comprising a GNSS user receiving device and a radio communications device, each said device operating with a dedicated antenna.

FIG. 2 illustrates one possible placement of antennas for a traditional system as illustrated in FIG. 1, if installed on an aircraft.

FIG. 3 illustrates a preferred embodiment of the present invention, wherein an aircraft installation of a VDL/4 radio communications device is integrated in a single chassis with a GNSS user receiving device, and the VDL/4 radio communications device and GNSS user receiving device share a single VHF antenna.

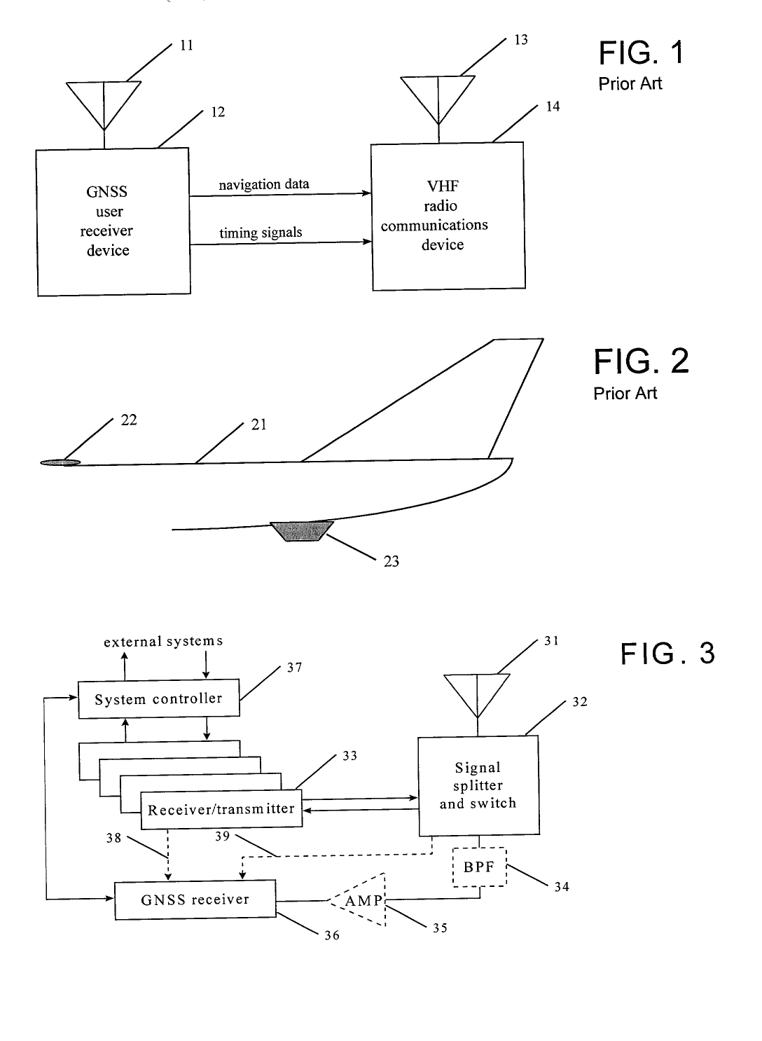

### DETAILED OF THE DESCRIPTION

Preferred embodiments of the present invention will be set forth with reference to FIG. 3.

FIG. 3 illustrates the use of a single antenna 31, in a preferred embodiment according to the present invention, for an integrated radio communications system, such as a VDL Mode 4 system, which relies in part on accurate positioning information and timing signals which may be derived from the GNSS. The integrated radio communications system comprises an antenna 31, a signal splitter and switch 32, a plurality of receiver/ transmitters 33, a GNSS user receiver device 36, and a system controller 37. The GNSS user receiver device 36 provides navigation and system timing for the radio communications system, for radio communication system management and synchronization, but is not otherwise used for aircraft navigation. If installed on an aircraft, the antenna 31 could be bottom-mounted as illustrated previously in FIG. 2. The signal splitter and switch 32 provides a fan-out of incoming RF signals to a plurality of receiver/transmitters 33, and also provides a switching means to switch a single active transmitter to the shared antenna while blocking the signal flow to the remaining receiver/transmitters, thereby preventing damage to the remaining receiver/transmitters. According to the present invention, the signal splitter and switch 32 also provides a fan-out of the incoming RF signals to the GNSS user receiver device 36. The signal splitter and switch 32 also blocks the signal flow from any of the active transmitters 33 to the GNSS user receiver device 36, thereby preventing damage to the GNSS user receiving device 36.

The antenna 31 may be designed for radio communications without regard to GNSS signal reception, and may be bottom-mounted. The cabling from the antenna to the signal splitter and switch 32 will introduce some additional loss (this cabling should be selected to accommodate the propagation of RF signals in the GNSS band of operation, as well as the band of operation used for radio communications by the radio communications system, with acceptably low loss). The signal splitter 32 will also reduce the signal strength available to the GNSS user receiver device 36. These factors will impair the signal strength available to the GNSS user receiver device 36. Nevertheless, there will be sufficient signal strength to allow intermittent or continuous (but degraded) operation of the GNSS user receiver device 36. This intermittent or continuous (but degraded) operation of the GNSS user receiver device 36 is sufficient to support the radio communication system management and synchronization requirements of the integrated radio communications system.

In a second embodiment of the present invention intended to enhance the operational availability and reliability of the GNSS user receiver device 36, an optional bandpass filter means 34 and amplifier means 35 are added in the signal path from the signal splitter 32 to the GNSS user receiver device 36. Alternatively or in addition to said optional means, signals outside the GNSS frequency band of operations are routed to an enhanced GNSS user receiver device along separate signal paths 39, and processed signals, measurements or data are passed from one or more of the receiver/transmitters 33 along other separate signal paths 38. Said signals, measurements and data, passed to an enhanced GNSS user receiver device along separate optional signal paths 38 and/or 39, are used to stabilize the acquisition and signal tracking performance of the enhanced GNSS user receiver device according to techniques known in the prior art (recently disclosed). Examples of said signals outside the GNSS frequency band of operations, which may be used singly or in combination to stabilize the acquisition and signal tracking performance of the enhanced GNSS user receiver device, include but are not limited to VOR signals, FM broadcast signals, TV broadcast signals and VDL Mode 4 signals transmitted from ground stations.

In a third embodiment of the present invention, an ultra-stable oscillator is also used to stabilize the GNSS user receiver device.

Initial GNSS signal acquisition while an aircraft is stationary on the ground, using the methods disclosed, can be used to stabilize the oscillator and initiate tracking of GNSS signals. Once the oscillator state is stabilized, it can coast through short periods of signal loss and maintain GNSS signal tracking while the aircraft is in flight.

In a fourth embodiment of the present invention, position information required by the integrated radio communications system is provided by an external source and the GNSS user receiver device, operating through the common antenna 31, is used only for the generation of appropriate timing signals.

While various preferred embodiments of the present invention have been set forth above, those skilled in the art who have reviewed the present disclosure will readily appreciate that other embodiments can be realized within the scope of the invention. For example, protocols other than those specifically set forth above can be implemented. Therefore, the present invention should be construed as limited only by the appended claims.

I claim:

1. A system comprising:
a GNSS user receiving device;
a radio communications device;
a single antenna shared by the GNSS user receiving device and the radio communications device; and
a signal splitter and switch for selectively connecting the single antenna to the GNSS user receiving device or to the radio communications device.

2. The system of claim 1, further comprising a means to enhance performance of the GNSS user receiving device based on tracking of signals available outside the GNSS frequency band of operations.

3. The system of claim 1, wherein the radio communications device comprises a VHF radio communications device installed on an aircraft.

4. The system of claim 3, further comprising a means to enhance performance of the GNSS user receiving device based on tracking of signals available outside the GNSS frequency band of operations.

5. The system of claim 1, wherein the radio communications device comprises a VDL Mode 4 radio communications device installed on an aircraft.

6. The system of claim 5, further comprising a means to enhance performance of the GNSS user receiving device based on tracking of signals available outside the GNSS frequency band of operations.

7. The system of claim 5, wherein the GNSS user receiving device is employed for the limited purpose of generating appropriate time signals.

8. A system comprising:
a plurality of communications devices, each with an embedded GNSS user receiving device; and
a single separate antenna to which each communications device with the embedded GNSS user receiving device is connected locally;
wherein the plurality of communications devices with the embedded GNSS user receiving devices exchange RF, IF or sampled-data equivalent signals associated with the GNSS, and the embedded GNSS user receiving devices process said exchanged signals in addition to the GNSS signals received via said locally-connected antenna.
